(19) United States
(12) Patent Application Publication
(10) Pub. No.: US 2024/0327113 A1
(43) Pub. Date: Oct. 3, 2024

(54) DECORATIVE TRASH RECEPTACLE SYSTEM AND KIT

(71) Applicant: Patricia H. Gilley, Wrightsville Beach, NC (US)

(72) Inventor: Patricia H. Gilley, Wrightsville Beach, NC (US)

(21) Appl. No.: 18/622,198

(22) Filed: Mar. 29, 2024

Related U.S. Application Data
(60) Provisional application No. 63/456,054, filed on Mar. 31, 2023.

(51) Int. Cl. B65F 1/14; B65F 1/08

(52) U.S. Cl. CPC B65F 1/14; B65F 1/085

(57) ABSTRACT

A decorative trash receptacle system and kit that display patterns through a transparent outer surface and allows users to selectively make changes to the display. The elements comprise inner and outer receptacles nestled together with decorative material comprising a pattern on one face thereof sandwiched between them. The sidewall of the outer receptacle is transparent, and the pattern is positioned to be viewed through the transparent wall of the outer receptacle. A retainer ring or a template may be positioned to secure and ensure the decorative material remains in place between the interior and exterior wall surfaces of outer and inner receptacles, respectively, so that the pattern is visibly displayed.

### CROSS-REFERENCE TO RELATED APPLICATIONS

This application claims the benefit of U.S. Provisional Patent Application No. 63/456,054, filed Mar. 31, 2023, and titled “Decorative Trash Can,” which is incorporated herein by reference.

### BACKGROUND OF THE INVENTION

This invention relates generally to a decorative trash receptacle system and kit and, more particularly, to a decorative waste or trash receptacle system that allows a user to use the receptacle as a decorative display for one or more personally selected graphic images, photographs, patterns, colors, and the like decorative elements (all encompassed within the term “pattern” as hereafter used); and to change the pattern and, thus, the appearance of the receptacle, as desired from time to time.

When selecting a trash receptacle, a user is limited in finding and selecting one that matches or otherwise decoratively enhances the decor and furnishings of the room where the trash receptacle is used. One approach to solving this problem is to custom manufacture a trash receptacle onto which a selected pattern is permanently affixed, using any of several techniques known in the art. However, customizing a decorative trash receptacle is not always economically feasible, and once created, the appearance cannot readily be altered.

### SUMMARY OF THE INVENTION

The present invention discloses a decorative trash receptacle system and kit that enables users to use the receptacle as a decorative display for a personally selected pattern; and to change the pattern and, thus, the appearance of the receptacle, as desired from time to time. The user may choose a pattern to match aspects of a room where the trash receptacle is placed, such as a pattern that is identical to the room's wallpaper, or my choose to select or create a pattern that fits their own decorative preference in some other manner. For example, the pattern could be a solid color, multiple colors, or black-and-white or grayscale pattern, in any arrangement or design, or could be some other image such as a photograph or cartoon or artwork, or montage thereof.

The trash receptacle system comprises a substantially transparent outer trash receptacle member and an inner trash receptacle member. The sidewall of the outer trash receptacle member comprises a viewing window: a substantially transparent material, such as clear plastic, through which the pattern can be viewed. Preferably, the outer trash receptacle is entirely transparent, and the entire sidewall comprises the viewing window. The inner trash receptacle comprises a rigid material, preferably a metal such as stainless steel. A decorative material displaying a pattern on at least one face thereof, such as a piece of wallpaper or other flexible material displaying a pattern selected by a user, is trimmed and configured, preferably using the template described below, to fit inside the outer receptacle, with the face on which the pattern is displayed being in physical contact with or close proximity to the interior wall of the outer receptacle. This arrangement of the decorative material inside the outer receptacle allows the pattern to be viewed through the sidewall of the outer receptacle.

The trash receptacle system preferably also comprises a template. The template serves as a cutting guide for cutting the decorative material and is of an appropriate size and shape so that the decorative material, once cut by the user, will fit between the inner and outer receptacles with the pattern visible through the viewing window of the outer receptacle. When using the template as a cutting guide, the user may, for example, trace around the pattern onto the decorative material and then cut the decorative material; or may cut directly around the periphery of the template whilst the template is laid on the decorative material. Preferably the template is sized to substantially match the interior surface of the sidewall of the outer trash receptacle member. Preferably, the mating ends of the template are slightly elongated, allowing for the two mating ends of the template to overlap slightly so as to prevent gaps when the decorative material is cut and placed, this overlap coming within the meaning of “substantially” as used herein. In some embodiments, the template is self-supporting and is sufficiently flexible to fit within the trash receptacle between the inner and outer receptacles. (For example, the template may be made of a flexible posterboard or a flexible plastic.) In some embodiments, the template comprises a pattern on at least one face thereof.

In some embodiments, the trash receptacle system comprises a retainer ring element of a predetermined size. The retainer ring is slidably inserted into the outer receptacle and configured to rest at the bottom. In this position, the retainer ring biases, or braces and secures, the decorative material into physical contact with or close proximity to the inside wall of the outer receptacle. The inner receptacle's height measurement is less than the height of the outer receptacle but sufficient to contact the wallpaper throughout the interior of the outer receptacle. The inner receptacle is shorter than the outer receptacle because the inner receptacle is designed to nest inside the outer receptacle, with the base of the inner receptacle on top of the retainer ring.

In some embodiments, there is no retainer ring element. In some such embodiments, it is sufficient to insert the inner receptacle as support for the decorative material so that it does not slump down in the cavity between the inner and outer receptacles over time. In other embodiments, the template or a second support element of size and shape equivalent to the template (and therefore falling within the meaning of “template” as used herein) may be disposed in the outer receptacle, adjacent to and behind the decorative material, to support the decorative material and prevent it from slumping down within the cavity between the inner and outer receptacles. In other embodiments, the decorative material is itself sufficiently self-supporting to prevent slumping; or the template may itself comprise the decorative material, in either event resulting in the need for only one component between the inner and outer receptacles.

The top of the inner receptacle preferably comprises an upper edge that extends outward such that at least a portion thereof overlaps and covers at least a portion of the top edge of the outer receptacle when the two receptacles are fitted together, thereby covering the cavity between the inner receptacle and the outer receptacle. This upper edge can serve any or all of multiple functions: it can operate to disguise the fact that there are two receptacles nested together; it can operate to prevent moisture from entering the cavity between the two receptacles in which the decorative material is housed; and it can ease removal of the inner receptacle when it is desired to separate the two receptacles. In one embodiment, the outwardly extending upper edge of the inner receptacle is U-shaped or grooved, and the top edge of the outer receptacle fits securely within the U-shaped portion or groove.

### BRIEF DESCRIPTION OF DRAWINGS

Various embodiments in accordance with the present disclosure will be described with reference to the drawings in which:

FIG. 1 is a side view illustrating the decorative trash receptacle system in assembled form, with a pattern displayed in accordance with some embodiments.

FIG. 2 is a side view illustrating the decorative trash receptacle system in assembly form, with a different pattern displayed in accordance with some embodiments.

FIG. 3 is a front perspective view illustrating the decorative trash receptacle system's disassembled components, which comprise an outer transparent receptacle, an inner receptacle, a retainer ring, a template, and decorative material with a pattern on one face thereof, shown in the facedown position so that the pattern is not visible, in accordance with some embodiments.

FIG. 4 is a back perspective view illustrating the decorative trash receptacle system's disassembled components, which comprise an outer transparent receptacle, an inner receptacle, a retainer ring, a template, and decorative material comprising a pattern on one face thereof, shown with the pattern face in a facedown position.

FIG. 5 is a top view illustrating the system and kit's disassembled components, which comprise an outer transparent receptacle, an inner receptacle, a retainer ring, a template, and decorative material comprising a pattern on one face thereof, shown with the pattern face in a facedown position.

FIG. 6 is a half section view of the decorative trash receptacle system illustrating the internal features along lines 6-6 in FIG. 1.

FIG. 7 is a half section view of the decorative trash receptacle system illustrating the internal features along lines 7-7 in FIG. 2.

### DETAILED DESCRIPTION OF THE INVENTION

The following discussion describes various embodiments of systems, kits, and apparatus. However, discussing these embodiments should not be construed as limiting the invention to these embodiments since those skilled in the pertinent art will also know various other embodiments.

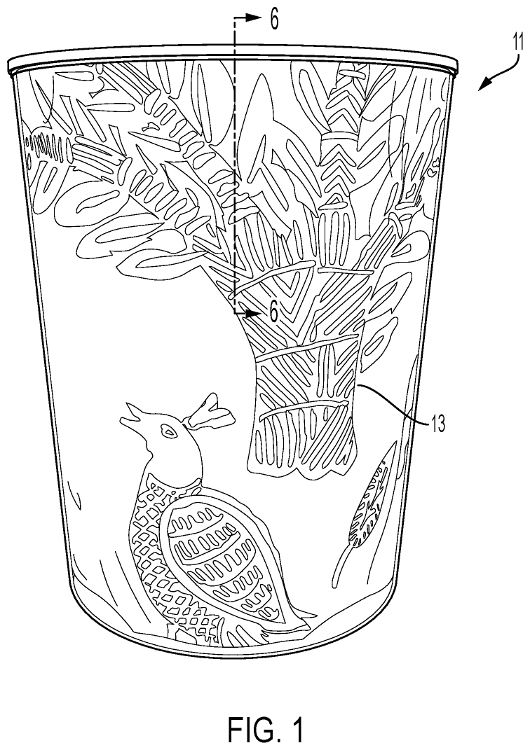

FIG. 1 is a side view illustrating the assembled decorative trash receptacle system and kit 11 in accordance with some embodiments. The design enables users to select a pattern 13 to blend with the room's decor or otherwise provide a desired decorative element. Pattern 13 is shown displayed on decorative material such as wallpaper. The system and kit 11 allow a user to easily change the decorative material comprising the selected pattern as desired from time to time, disassembling and assembling the inner and outer receptacles in order to make the change without damage to those elements and without needing tools or adhesives. In accordance with this embodiment, the pattern 13, which is displayed on decorative material disposed around the exterior surface of the system and kit 11, is selected by a user. The pattern is visible through the outer surface of the assembled system and kit 11.

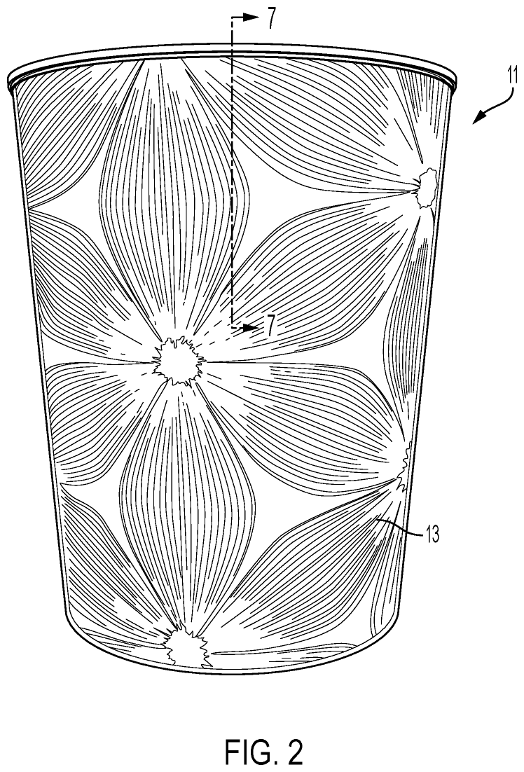

FIG. 2 illustrates a side view of a decorative trash receptacle 11 in an upright vertical position and with selected pattern 14 displayed on decorative material extending around the exterior of the inner receptacle, and visible to a viewer through the outer receptacle, which is transparent in at least the areas through which it is desired to view the pattern. In accordance with this embodiment, the pattern 14 is selected by a user.

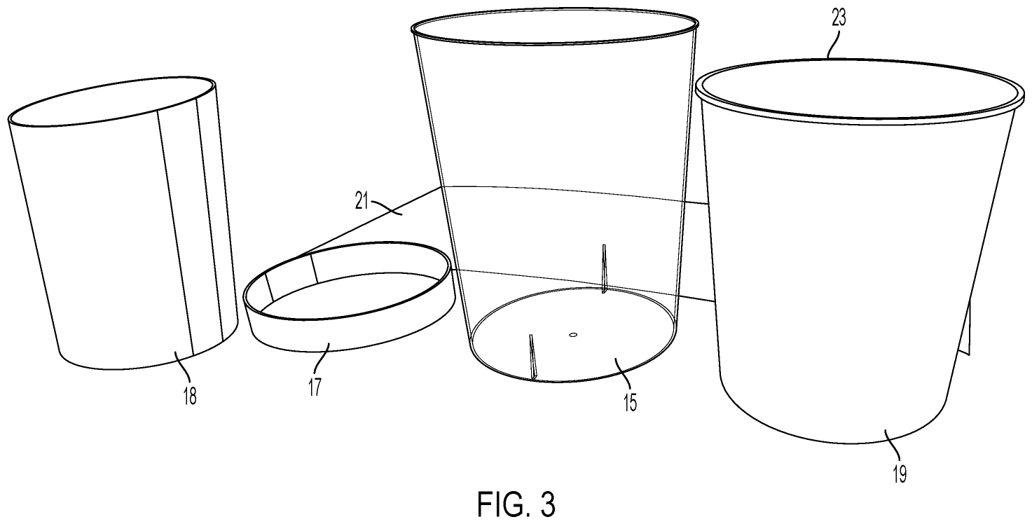

FIG. 3 is a front perspective view illustrating the decorative trash receptacle system and kit 11 in disassembled form in accordance with one embodiment. The system and kit components comprise an outer receptacle 15, made of transparent material such as clear plastic, with decorative material 21 displaying a pattern on one face thereof. Decorative material 21 (displaying on at least one face a pattern selected by the user) is cut to a predetermined size for placement into the interior of outer receptacle 15 so as to display the pattern through the transparent wall of outer receptacle 15. In accordance with one embodiment, a retainer ring 17 is slidably inserted by the user within outer receptacle 15 at the bottom to ensure that decorative material 21 remains in abutment with the exterior wall of the outer receptacle 15 in a press-fit arrangement without the need for adhesives, notches, tabs, and the like.

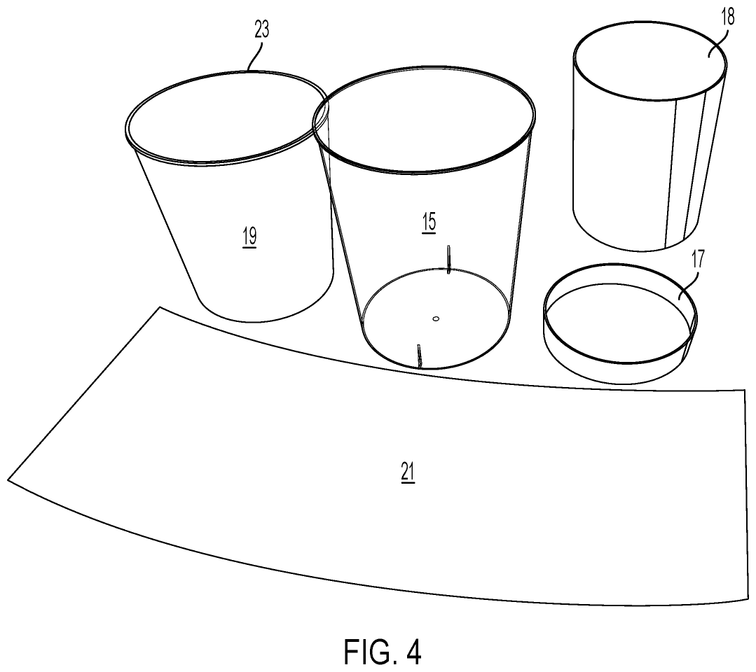

Still referring to FIG. 3 and now also to FIG. 4, where FIG. 4 is a back or rear perspective view illustrating the system and kit in disassembled form. Inner receptacle 19, optionally made of metal, is constructed of slightly smaller dimensions than the outer receptacle 15. In the embodiment shown in FIG. 3 and FIG. 4, inner receptacle 19 rests on the top edge of retainer ring 17. Inner receptacle 19, much like the retainer ring beneath it, holds the decorative material 21 in a sandwich arrangement between the interior wall of outer receptacle 15 and the exterior wall of inner receptacle 19. The top of inner receptacle 19 comprises an upper edge 23 that extends outward such that at least a portion thereof overlaps and covers at least a portion of the top edge of the outer receptacle 15 when the two receptacles are fitted together. In this embodiment, the outwardly extending upper edge 23 of inner receptacle 19 is configured as a U-shaped edge. When the inner receptacle 19 is placed within the outer receptacle 15, then as shown here, the outwardly extending upper edge 23 of inner receptacle 19 rests on the top edge of the outer receptacle 15 and the top edge of the outer receptacle 15 is received within the U-shaped section of outwardly extending upper edge 23 of inner receptacle 19.

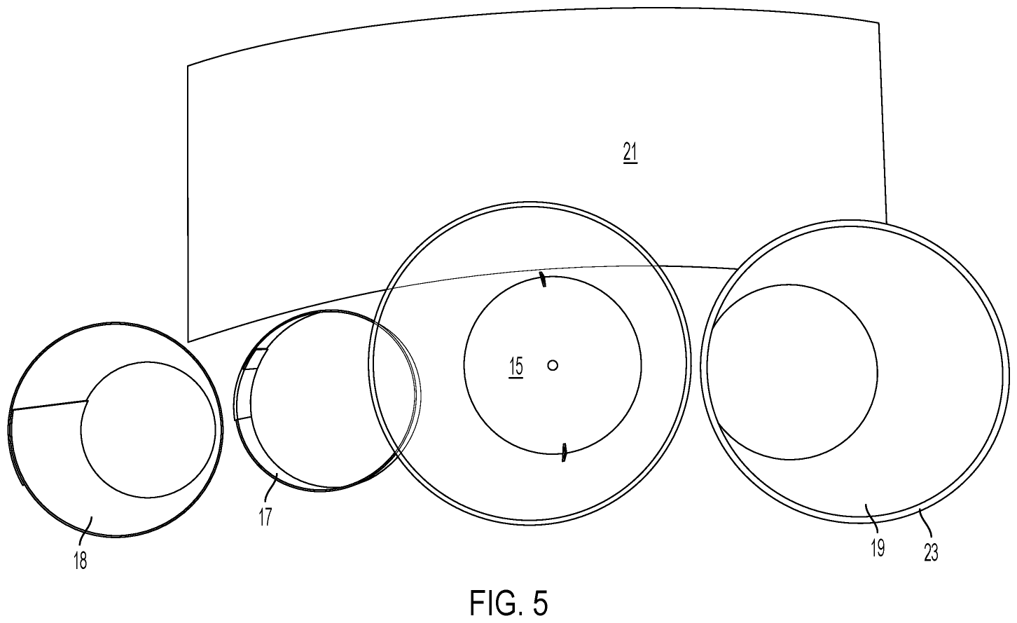

FIG. 5 is a top view illustrating the system and kit's disassembled components as provided in one embodiment. The elements comprise an outer transparent receptacle 15, an inner receptacle 19, a retainer ring 17, a template 18, and decorative material 21. As depicted, pattern 13 is not visible because it is the downward-facing face of decorative material 21. According to some embodiments, the system and kit are adaptable, enabling users to assemble the various components quickly. For example, if desired to replace the decorative material 21 for another room or occasion, the user can quickly accomplish the change without using tools or adhesives and the like without harm to the parts.

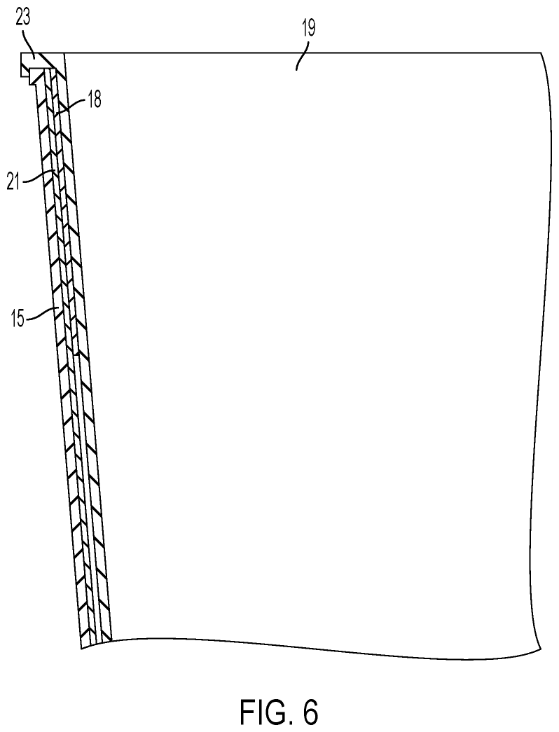

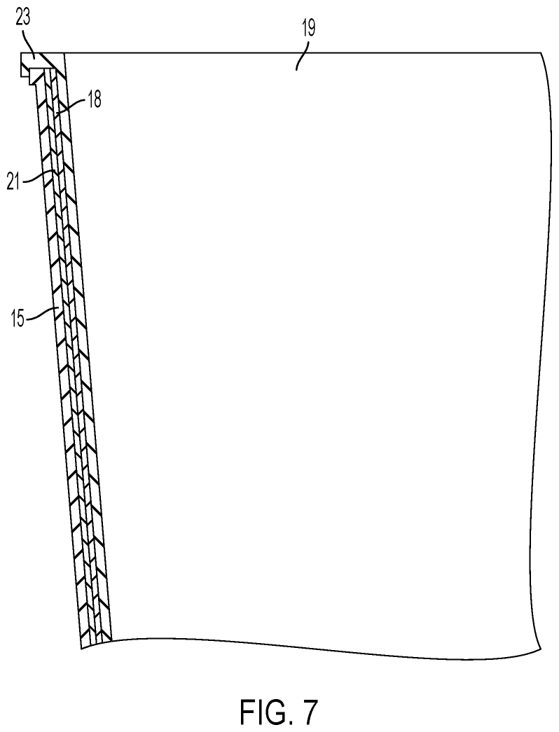

Turning now to FIG. 6 and FIG. 7, shown therein, FIG. 6 is a half section view illustrating the internal features of the assembled system and kit 11 along the line 6-6 in FIG. 1. FIG. 7 is a half-section view illustrating the internal features of assembled system kit 11 along the line 7-7 in FIG. 2. In these embodiments, retainer ring 17 is replaced with template 18. Template 18 is sufficiently flexible that it can wrap around the interior of outer receptacle 15, and is self-supporting so that it does not slump down when positioned within the cavity between the interior and outer receptacles. Template 18 may be made of plastic, cardboard, or another material having the desired characteristics. Template 18 is removably positioned within outer receptacle 15 to secure decorative material 21 in abutment with or close proximity to the exterior wall surface of the outer receptacle 15, preferably in a press-fit arrangement, without the need for adhesives, notches, tabs, and the like.

Decorative material 21 is not limited to wallpaper having a pattern on one face thereof. As indicated previously, the pattern displayed on decorative material could, for example, be one or more photographs of a user's children, artwork created by children, images or photographs of locations having emotional significance, advertisements, corporate logos, or other images. Decorative material 21 could be of paper, fabric, plastic, or other material that can be cut according to the template 18 and fitted within the outer receptacle 15. If decorative material 21 is itself self-supporting, then it is not necessary to employ retainer ring 17 or template 18 behind the decorative material 21 in order to secure it in position. However, it still is useful to place template 18 behind decorative material 21, so that all components of kit 11 are kept together, making it easier to locate the template if it is desired to change the pattern 13 and thus to cut a replacement decorative material 21 using template 18 as a guide.

While the invention and various embodiments have been described essentially as a single unit in assembled and disassembled forms, it is appreciated that the invention can employed as a kit to be assembled by a user, and over time the decorative pattern can be changed depending on the user's preferences. The kit may include a decorative material comprising a desired pattern, cut to the size of a template and itself usable as a template; an additional template may not, in such case, be included in the kit. Similarly, misplaced, or damaged parts can be readily replaced.

Having described the invention, the same will be more clearly understood from the appended claims in which it is described in a non-limiting manner.

What is claimed is:

1. A decorative trash receptacle system comprising:
a. an outer trash receptacle member that has a substantially transparent sidewall;
b. an inner trash receptacle member that has a sidewall sized to removably fit within the outer trash receptacle;
c. a cavity formed between the sidewall of the outer trash receptacle member and the sidewall of the inner trash receptacle member when the inner trash receptacle member is fitted within the outer trash receptacle member; and
d. a decorative material having a pattern thereon, sized and shaped to be retained within the cavity and to display the pattern through the transparent sidewall of the outer trash receptacle member.

2. A decorative trash receptacle system according to claim 1, further comprising a retainer ring, wherein the retainer ring is positioned inside said outer receptacle and pressed against the decorative material.

3. A decorative trash receptacle system according to claim 1, further comprising a template, sized and shaped to substantially match the size and shape of the sidewall of the inner trash receptacle member; and wherein the template is used as a cutting guide to form the size and shape of the decorative material.

4. A decorative trash receptacle system according to claim 1 wherein the template is positioned inside said outer receptacle and disposed against the decorative material.

5. A decorative trash receptacle system according to claim 1 wherein the inner trash receptacle member is removable from the outer trash receptacle member.

6. A decorative trash receptacle system according to claim 1 wherein the inner trash receptacle member further comprises an upper edge that extends outward and covers the cavity.

7. A decorative trash receptacle system according to claim 6 wherein the outer trash receptacle member further comprises an upper edge that is securely retained within the outwardly extending upper edge of the inner trash receptacle member.

8. A kit for use in displaying a pattern through an exterior surface of a decorative trash receptacle system comprising:
a. a substantially transparent outer trash receptacle member having a sidewall, the sidewall having an interior surface;
b. a template, the template comprising a cutting guide for decorative material having a pattern on at least one face thereof, the template being sized to substantially match the interior surface of the sidewall of the outer trash receptacle member; and
c. an inner trash receptacle member sized to sandwich, between said transparent outer trash receptacle member and said inner trash receptacle member, decorative material sized to match the template, whereby said decorative material is securely retained in place.

9. A kit for use in displaying a pattern through an exterior surface of a decorative trash receptacle system according to claim 8, further comprising: a retainer ring sized to fit within the outer trash receptacle and behind the decorative material when the decorative material is placed against the interior surface of the sidewall of the outer trash receptacle.

10. A kit for use in displaying a pattern through an exterior surface of a decorative trash receptacle system according to claim 8, further comprising a decorative material having a pattern thereon.

11. A kit for use in displaying a pattern through an exterior surface of a decorative trash receptacle system according to claim 8, wherein the template comprises a pattern on one face thereof.

12. A decorative trash receptacle kit comprising:
a. a substantially transparent outer trash receptacle member having an upper edge;
b. an inner trash receptacle member sized to fit within the outer trash receptacle, comprising an outwardly extending upper edge member sized to cover the upper edge of the outer trash receptacle member and configured to removably retain the inner trash receptacle member and the outer trash receptacle member in mated position when the inner trash receptacle member is placed within the outer trash receptacle member;
c. a template designed for cutting a decorative material having a pattern on a face thereof to fit between said outer trash receptacle member and said inner trash receptacle member when the inner trash receptacle member is placed within said outer trash receptacle member, with the pattern facing the outer trash receptacle member.

13. A decorative trash receptacle kit according to claim 12, further comprising: a decorative material having a pattern on at least one face thereof.

14. A decorative trash receptacle kit according to claim 13, wherein said decorative material is formed of a flexible self-supporting material and is sized and shaped to be disposed in abutment with an interior face of said transparent outer trash receptacle and to fit between said outer trash receptacle member and said inner trash receptacle member when the inner trash receptacle member is placed within said outer trash receptacle member, with the pattern facing the outer trach receptacle member.

15. A decorative trash receptacle kit according to claim 14 wherein said decorative material is said template.

16. A decorative trash receptacle kit according to claim 12 further comprising a retainer ring sized to fit within the outer trash receptacle and to retain the decorative material in abutment with the interior face of the outer trash receptacle.
